(19) United States
(12) Patent Application Publication
(10) Pub. No.: US 2025/0201973 A1
(43) Pub. Date: Jun. 19, 2025

(54) ENERGY STORAGE DEVICE

(71) Applicant: GS Yuasa International Ltd., Kyoto (JP)

(72) Inventors: Kazuya OKABE, Kyoto (JP); Ryoichi OKUYAMA, Kyoto (JP)

(73) Assignee: GS Yuasa International Ltd., Kyoto (JP)

(21) Appl. No.: 18/845,870

(22) PCT Filed: Jan. 12, 2023
(86) PCT No.: PCT/JP2023/000569

§ 371 Date: Sep. 10, 2024

(30) Foreign Application Priority Data
Mar. 15, 2022 (JP) 2022-040801

(51) Int. Cl. H01M 50/103; H01M 50/15; H01M 50/169

(52) U.S. Cl. CPC H01M 50/103; H01M 50/15; H01M 50/169

(57) ABSTRACT

An energy storage device includes a container including: a container main-body including a first opening portion opened in a first direction and a second opening portion opened in a second direction intersecting with the first direction; and a lid body closing the first opening portion and the second opening portion, the container main-body including: a first wall portion opposed to the first opening portion in the first direction; a second wall portion opposed to the second opening portion in the second direction; and a pair of third wall portions opposed to each other in a third direction intersecting with the first and second directions.

### TECHNICAL FIELD

The present invention relates to an energy storage device including a container.

### BACKGROUND ART

There is known a rectangular energy storage device formed by joining a cover forming one surface to a container main-body constituted by five surfaces. Meanwhile, an energy storage device provided with a container including a container main-body with surfaces other than five surfaces is known. For example, Patent Literature 1 discloses a sealed battery (an energy storage device) including a battery container having a first member (container main-body) with three surfaces, in which a rectangular bottom surface and a pair of long side surfaces are each formed of one first flat plate, and second and third flat plates constituting a pair of short side surfaces, respectively.

### CITATION LIST

### Patent Literature

Patent Literature 1: Japanese Patent Application Publication No. 2017-107773

### DISCLOSURE OF INVENTION

### Problems to Be Solved by the Invention

The container main-body constituted by five surfaces can be easily formed by press working. A terminal, a gas discharge valve, and the like can be easily disposed on a lid forming one surface. Further, by welding or the like the container main-body and the lid, an energy storage device can be easily formed to be airtight. However, in the above-mentioned Patent Literature 1, when the container main-body having five surfaces is manufactured by deep drawing molding, a variation in thickness is likely to be large, and when the container main-body having five surfaces is formed by bending a metal flat plate, there is a problem that a material yield is deteriorated. On the other hand, in the above-mentioned Patent Literature 1, the container main-body (first member) is formed by three surfaces of a bottom surface and a pair of long side surfaces, and flat plates constituting short side surfaces are joined to the container main-body by welding. However, in the configuration of Patent Literature 1, it is difficult to align the flat plate with the container main-body when the flat plate is joined to the container main-body. Therefore, these joining works are difficult, and a shape accuracy of the completed container may be deteriorated.

The present invention has been achieved by the inventor of the present invention by newly paying attention to the above problem, and an object of the present invention is to improve the shape accuracy of the container and to provide an energy storage device with excellent productivity.

### Means for Solving the Problems

An energy storage device according to an embodiment of the present invention is an energy storage device including a container, the container including: a container main-body having a first opening portion that is opened in a first direction and a second opening portion that is opened in a second direction intersecting with the first direction, and a lid body closing the first opening portion and the second opening portion, in which the container main-body includes a first wall portion opposed to the first opening portion in the first direction, a second wall portion opposed to the second opening portion in the second direction, and a pair of third wall portions opposed to each other in a third direction intersecting the first direction and the second direction.

### Effect of the Invention

According to the energy storage device in an embodiment of the present invention, the shape accuracy and the productivity of the container can be improved.

### BRIEF DESCRIPTION OF DRAWINGS

FIG. 1 is a perspective view illustrating an external appearance of an energy storage device according to an embodiment.

FIG. 2 is a perspective view illustrating a configuration of a container according to the embodiment.

FIG. 3 is a perspective view illustrating a manufacturing process of the container main-body according to the embodiment.

FIG. 4 is a perspective view illustrating a configuration of a container according to a modification example 1 of the embodiment.

FIG. 5 is a perspective view illustrating a configuration of a container according to a modification example 2 of the embodiment.

FIG. 6 is a perspective view illustrating a configuration of a container according to a modification example 3 of the embodiment.

### DESCRIPTION OF EMBODIMENTS

(1) An energy storage device according to an embodiment of the present invention is an energy storage device including a container, the container including: a container main-body having a first opening portion that is opened in a first direction and a second opening portion that is opened in a second direction intersecting with the first direction; and a lid body closing the first opening portion and the second opening portion, in which the container main-body includes a first wall portion opposed to the first opening portion in the first direction, a second wall portion opposed to the second opening portion in the second direction, and a pair of third wall portions opposed to each other in a third direction intersecting the first direction and the second direction.

In the energy storage device according to an embodiment of the present invention, the container main-body of the container includes the first wall portion opposed to the first opening portion in the first direction, the second wall portion opposed to the second opening portion in the second direction, and the pair of third wall portions opposed to each other in the third direction. When a container main-body having five surfaces is formed by press working (deep drawing molding) or the like, it is difficult to manufacture the container main-body, and when the container main-body having five surfaces is formed by bending a flat plate, there is a problem such as a decrease in material yield. By forming a container main-body having four surfaces, manufacturing is easy, and a decrease in material yield can also be suppressed. In a case of forming a container main-body having three surfaces, it may be difficult to perform alignment when the first wall portion or the second wall portion is joined to the container main-body having three surfaces. Therefore, the container main-body is formed by four surfaces of the first wall portion, the second wall portion, and the pair of third wall portions. Accordingly, since the container main-body can be easily formed, the shape accuracy and the productivity of the container can be improved.
(2) In the energy storage device according to the above (1), the first wall portion or the second wall portion may be formed with a first joint portion in which two portions constituting the first wall portion or the second wall portion are joined to each other.

According to the energy storage device described in the above (2), the first wall portion or the second wall portion is formed by joining the two portions, whereby it is possible to easily form the container main-body having four surfaces, which includes the first wall portion, the second wall portion, and the pair of third wall portions.
(3) In the energy storage device according to the above (2), the second wall portion may be smaller in size than the first wall portion, and the first joint portion may be formed on the second wall portion.

According to the energy storage device described in the above (3), the first joint portion is formed on the second wall portion having a size smaller than that of the first wall portion, whereby the length of the first joint portion can be shortened, and thus the joining work is easy.
(4) In the energy storage device according to any one of the above (1) to (3), the lid body may include a fourth wall portion that closes the first opening portion, and a fifth wall portion that closes the second opening portion.

According to the energy storage device described in the above (4), the lid body is formed by two surfaces of the fourth wall portion and the fifth wall portion which close the first opening portion and the second opening portion, whereby it is possible to easily align the container main-body and the lid body. As a result, since it is easy to dispose the lid body having two surfaces on the container main-body having four surfaces, the joining work of the container main-body and the lid body is easy.
(5) In the energy storage device described in any one of the above (2) to (4), the first joint portion may be formed by joining a pair of portions extending from the pair of third wall portions.

According to the energy storage device described in the above (5), by forming the first wall portion or the second wall portion by joining the pair of portions extending from the pair of third wall portions, the first wall portion or the second wall portion can be easily formed.
(6) In the energy storage device according to any one of the above (1) to (5), the second wall portion may have a width in the third direction that is smaller than a width thereof in the first direction.

According to the energy storage device described in the above (6), the width of the second wall portion of the container main-body has a width in the third direction that is smaller than the width in the first direction, the elongated lid body is disposed on the container main-body. Thus, the container main-body and the lid body can be easily aligned with each other, and therefore, the joining work of the container main-body and the lid body can be easily performed.
(7) The energy storage device according to any one of the above (1) to (6) may further include a pair of electrode terminals, and the pair of electrode terminals may be disposed on the lid body.

According to the energy storage device described in the above (7), by disposing both of the pair of electrode terminals on the lid body, the container main-body and the lid body can be joined in a state where members (a current collector, and electrode assembly, and the like) disposed in the container are fixed to the lid body, and therefore, the energy storage device can be easily manufactured.
(8) In the energy storage device according to any one of the above (1) to (7), a wall portion that closes the first opening portion included in the lid body may be larger than a width of the pair of third wall portions in the second direction, and larger than a distance between the pair of third wall portions in the third direction, and a wall portion that closes the second opening portion included in the lid body may be larger than the width of the pair of third wall portions in the first direction, and larger than the distance between the pair of third wall portions in the third direction.

According to the energy storage device described in the above (8), the wall portion of the lid body is larger than the width of the third wall portion and is larger than the distance between the pair of third wall portions in the third direction.

Accordingly, since the lid body covers the opening portion of the container main-body, the container main-body and the lid body can be easily aligned by pressing the lid body against the container main-body.
(9) In the energy storage device according to any one of the above (1) to (8), the container main-body may be formed with a second joint portion in which the first wall portion or the second wall portion and the third wall portion are joined to each other.

According to the energy storage device described in the above (9), the container main-body can be easily formed from one plate.

Hereinafter, an energy storage device according to embodiments (including modification examples thereof) of the present invention will be described with reference to the drawings. Each of the embodiments to be described below illustrates a comprehensive or specific example. A numerical value, a shape, a material, a component, a disposed position and connection configuration of the components, manufacturing processes, an order of manufacturing processes, and the like, which will be described in the following embodiment, are merely examples, and are not intended to limit the present invention. In the drawings, dimensions and the like are not strictly illustrated. In the drawings, the same or similar components are denoted by the same reference numerals.

In the following description and drawings, an arrangement direction of a pair of electrode terminals (a positive electrode and a negative electrode, the same applies hereinafter) of an energy storage device, an arrangement direction of a pair of current collectors, a direction in which a pair of short side surfaces of a container are opposed to each other, or a direction in which the container extends is defined as an X-axis direction. A direction in which a pair of long side surfaces of the container are opposed to each other or a thickness direction (flat direction) of the container or an electrode assembly is defined as a Y-axis direction. A protruding direction of the electrode terminal, an arrangement direction of the electrode terminal and the electrode assembly, an arrangement direction of the container main-body and the lid body, or an up-down direction is defined as a Z-axis direction. The X-axis direction, the Y-axis direction, and the Z-axis direction are directions intersecting with each other (orthogonal to each other in the present embodiment). Although there may be a case where the Z-axis direction does not conform to the up-down direction depending on a use mode, the Z-axis direction will be described as the up-down direction in the following for convenience of description.

In the following description, for example, an X-axis positive direction indicates a direction of an arrow in the X-axis, and an X-axis negative direction indicates a direction opposite to the X-axis positive direction. When simply referred to as the X-axis direction, it indicates both or one of the X-axis positive direction and the X-axis negative direction. The same applies to the Y-axis direction and the Z-axis direction. Hereinafter, the Z-axis direction is also referred to as a first direction, the X-axis direction is also referred to as a second direction, and the Y-axis direction is also referred to as a third direction. Expressions indicating relative directions or postures, such as parallel and orthogonal, include cases where the directions or postures are not parallel or orthogonal in a strict sense. Two directions being parallel to each other means not only that the two directions are completely parallel to each other, but also that the two directions are substantially parallel to each other, in other words, a difference by several percent or so, for example, is included in the scope. In the following description, when the expression “insulation” is used, “insulation” is intended as “electrical insulation”.

### Embodiment

### 1. General Description of Energy Storage Device 10

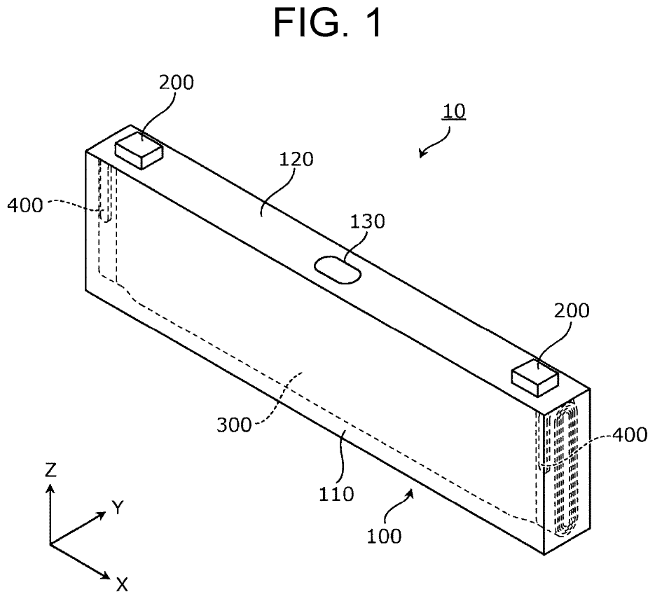

First, a general description of the energy storage device 10 in the present embodiment will be given. FIG. 1 is a perspective view illustrating an external appearance of the energy storage device 10 according to the present embodiment.

The energy storage device 10 is a secondary battery (a single cell) capable of charging electricity and discharging electricity, and more specifically, is a non-aqueous electrolyte secondary battery such as a lithium-ion secondary battery. The energy storage device 10 is used for a power storage application, a power supply application, or the like. Specifically, the energy storage device 10 is used as a battery for driving or starting an engine of a movable body such as an automobile, a motorcycle, a watercraft, a container, a snowmobile, an agricultural machine, a construction machine, or a railway vehicle for electric railway. As the above-mentioned automobile, an electric vehicle (EV), a hybrid electric vehicle (HEV), a plug-in hybrid electric vehicle (PHEV), and a fossil fuel (gasoline, light oil, liquefied natural gas, or the like) automobile are exemplified. As the above-mentioned railway vehicle for electric railway, a train, a monorail, a magnetic levitation train, and a hybrid train provided with both a diesel engine and an electric motor are exemplified. The energy storage device 10 can also be used as a stationary battery or the like that is used for home, business, or the like.

The energy storage device 10 has a long shape in the X-axis direction. In the present embodiment, the energy storage device 10 has a rectangular parallelepiped shape (square shape) that is flat in the Y-axis direction. The energy storage device 10 is not limited to the non-aqueous electrolyte secondary battery, and may be a secondary battery other than the non-aqueous electrolyte secondary battery, or may be a capacitor. The energy storage device 10 may not be a secondary battery, but may be a primary battery capable of using electricity that is stored even without being charged by a user. The energy storage device 10 may be a battery using a solid electrolyte. In this embodiment, an example is given by using a lithium-ion secondary battery using a nonaqueous electrolyte.

As illustrated in FIG. 1, the energy storage device 10 includes a container 100 and a pair of (positive electrode and negative electrode) electrode terminals 200, and an electrode assembly 300 and a pair of (positive electrode and negative electrode) current collectors 400 are accommodated in the container 100. An electrolyte solution (non-aqueous electrolyte) is also sealed inside the container 100, and a gasket is disposed between the electrode terminal 200 and the current collector 400, and the container 100 (a lid body 120 to be described below), but these are not illustrated in the drawings. The type of the electrolytic solution is not particularly limited as long as the performance of the energy storage device 10 is not impaired, and various electrolytic solutions can be selected. The gasket may be formed of any material as long as it has an insulating property. In addition to the above-described components, the energy storage device 10 may include a spacer disposed on a side of or below the electrode assembly 300, or the like, an insulating film wrapping the electrode assembly 300 and the like, an insulating film (a shrink tube or the like) covering the outer surface of the container 100, and the like.

The container 100 is a case having a flat rectangular parallelepiped shape (a square shape or a box shape), the case including a container main-body 110 in which an opening is formed and a lid body 120 that closes the opening of the container main-body 110. In this embodiment, the container 100 has a long-sized shape in the X-axis direction. The length of the container 100 in the X-axis direction may be three times or more the length in the Z-axis direction. The container main-body 110 is a member constituting a main-body portion of the container 100, and the lid body 120 is a member constituting a cover portion of the container 100. The lid body 120 is provided with a gas discharge valve 130 for releasing a pressure inside the container 100 when the pressure rises excessively. The gas discharge valve 130 may be provided in the container main-body 110. The container 100 (the container main-body 110 or the lid body 120) may be provided with a liquid injection portion or the like for injecting an electrolytic solution into the container 100. The material of the container 100 (the container main-body 110 and the lid body 120) is not particularly limited, and can be, for example, a weldable metal, such as stainless steel, aluminum, aluminum alloy, iron, or a plated steel plate, but a resin can also be used.

The container 100 has a configuration in which the interior of the container 100 is sealed (tightly sealed), which is acquired by accommodating the electrode assembly 300 and the like inside the container main-body 110, and thereafter having the container main-body 110 and the lid body 120 joined to each other by welding or the like. The container 100 has a pair of long side surfaces on both side surfaces in the Y-axis direction, a pair of short side surfaces on both side surfaces in the X-axis direction, a bottom surface on a surface in a Z-axis negative direction, and a terminal arrangement surface on which the electrode terminals 200 are disposed on a surface in a Z-axis positive direction. As described above, the container 100 is a container that is flat in the Y-axis direction and in which the thickness direction is the Y-axis direction, and has a long shape in the X-axis direction. A configuration of the container 100 will be described in detail below.

The electrode terminals 200 are terminal members (a positive electrode terminal and a negative electrode terminal) of the energy storage device 10 disposed on the lid body 120 of the container 100. Specifically, a pair of electrode terminals 200 aligned in the X-axis direction are disposed so as to protrude in the Z-axis positive direction from the upper surface (terminal disposition surface) of the lid body 120. The electrode terminal 200 is electrically connected to a positive electrode plate and a negative electrode plate of the electrode assembly 300 via the current collector 400. Namely, the electrode terminal 200 is a metal member for leading out electricity stored in the electrode assembly 300 to an outer space of the energy storage device 10 and for introducing electricity into the internal space of the energy storage device 10 in order to store the electricity in the electrode assembly 300. The electrode terminal 200 is formed of aluminum, an aluminum alloy, copper, a copper alloy, or the like. The electrode terminal 200 is connected (joined) to the current collector 400 by caulking or the like, and is attached to the lid body 120. A method of connecting (joining) the electrode terminal 200 and the current collector 400 is not limited to caulking joining, and welding such as ultrasonic joining, laser welding, or resistance welding, mechanical joining other than caulking such as screw coupling, or the like may be used.

The electrode assembly 300 is an energy storage element (power generation element) capable of storing electricity, and includes a positive electrode plate, a negative electrode plate, and a separator, and is formed by laminating the positive electrode plate, the negative electrode plate, and the separator. The positive electrode plate is an electrode plate in which a positive electrode active material layer is formed on a positive electrode substrate which is a current collector foil made of a metal such as aluminum or an aluminum alloy. The negative electrode plate is an electrode plate in which a negative electrode active material layer is formed on a negative electrode substrate which is a current collector foil made of a metal such as copper or a copper alloy. The separator is a microporous sheet made of a resin, or a resin, an inorganic substance, and the like. As a positive electrode active material used for the positive electrode active material layer and a negative electrode active material used for the negative electrode active material layer, known materials can be appropriately used as long as they can occlude and release lithium ions. As the separator, a known material can be appropriately used as long as the performance of the energy storage device 10 is not impaired.

In the present embodiment, the electrode assembly 300 is a wound electrode assembly formed in such a manner that a positive electrode plate, a negative electrode plate, and a separator interposed therebetween are arranged in layers and wound around a winding shaft parallel to the X-axis direction. Specifically, in the electrode assembly 300, the positive electrode plate and the negative electrode plate are wound via the separator in such a way as to be shifted from each other in a direction of the winding shaft (X-axis direction). The positive electrode plate and the negative electrode plate each have a portion where a base material is exposed without being coated with the active material at an end portion in the shifted direction, and the end portion is electrically and mechanically connected to the current collector 400. The electrode assembly 300 has a long-sized shape extending in the X-axis direction and has an oval shape when viewed from the X-axis direction. The electrode assembly 300 has a shape in which a length thereof in the X-axis direction is, for example, 300 mm or more, and specifically, extends to about 500 mm to 1500 mm. Therefore, the length of the electrode assembly 300 in the X-axis direction is longer than the length thereof in the Z-axis direction. The length of the electrode assembly 300 in the X-axis direction may be three times or more the length thereof in the Z-axis direction. The electrode assembly 300 may be a wound electrode assembly formed by winding a positive electrode plate, a negative electrode plate, and a separator around a winding shaft parallel to the Z-axis direction. The electrode assembly 300 may be a laminated (stacked) electrode assembly formed by laminating a plurality of flat plate-shaped polar plates, a bellows-type electrode assembly formed by folding a polar plate into a shape of a bellows, or an electrode assembly of an other form.

The current collector 400 is a conductive current collecting member (a positive electrode current collector and a negative electrode current collector) disposed between the electrode assembly 300 and the container 100 and electrically connected to the electrode terminal 200 and the electrode assembly 300. The current collector 400 of the positive electrode is connected (joined) to the positive electrode plate of the electrode assembly 300 by welding or the like, and is connected (joined) to the electrode terminal 200 of the positive electrode by caulking or the like. The current collector 400 of the negative electrode is connected (joined) to the negative electrode plate of the electrode assembly 300 by welding or the like, and is connected (joined) to the electrode terminal 200 of the negative electrode by caulking or the like. The current collector 400 of the positive electrode is formed of aluminum, an aluminum alloy, or the like similarly to the positive electrode substrate of the positive electrode plate of the electrode assembly 300, and the current collector 400 of the negative electrode is formed of copper, a copper alloy, or the like similarly to the negative electrode substrate of the negative electrode plate of the electrode assembly 300. A method of connecting (joining) the current collector 400 and the electrode assembly 300 is not limited to welding, and caulking joining or the like may be used.

### 2 Description of Container 100

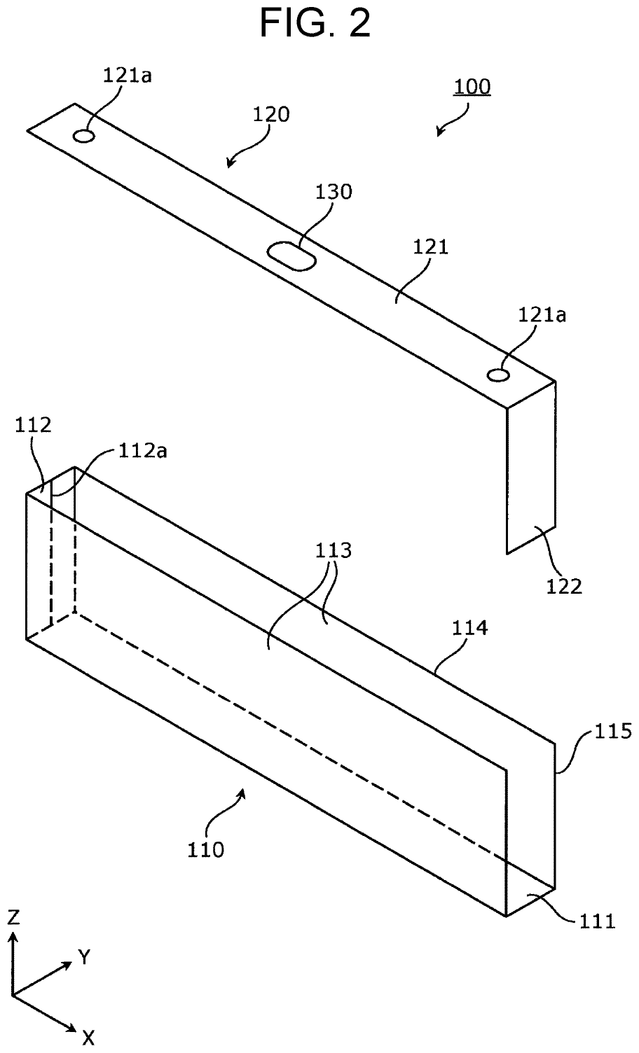

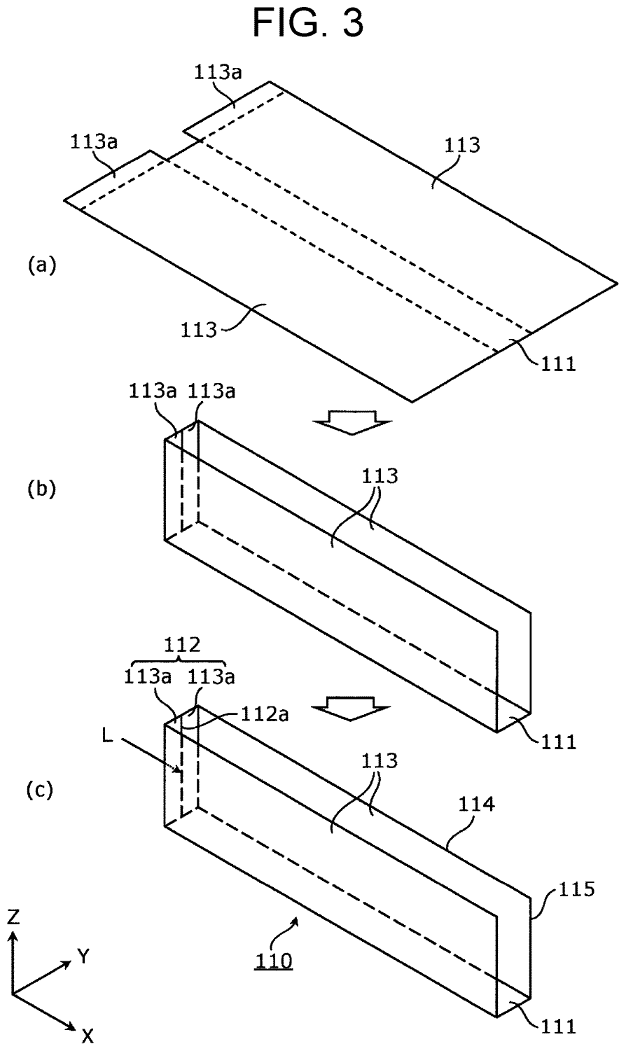

Next, the configuration of the container 100 (the container main-body 110 and the lid body 120) will be described in detail. FIG. 2 is a perspective view illustrating a configuration of the container 100 according to the present embodiment. FIG. 2 illustrates respective configurations of the container main-body 110 and the lid body 120 of the container 100 by separating the container main-body 110 and the lid body 120. FIG. 3 is a perspective view illustrating a manufacturing process of the container main-body 110 according to the present embodiment.

As illustrated in FIG. 2, the container main-body 110 of the container 100 includes a first wall portion 111 facing in the Z-axis direction, a second wall portion 112 facing in the X-axis direction, and a pair of third wall portions 113 facing in the Y-axis direction. Accordingly, the container main-body 110 has a first opening portion 114 that is opened in the Z-axis direction (first direction), and a second opening portion 115 that is opened in the X-axis direction (second direction intersecting with the first direction).

The first wall portion 111 is a wall (bottom wall) that forms a surface (bottom surface) of the container main-body 110 in the Z-axis negative direction, and opposed to the first opening portion 114 in the Z-axis direction (first direction). The first wall portion 111 is a long-sized portion having a flat plate shape and a rectangular shape, which extends in the X-axis direction parallel to an XY plane. In external dimensions, a width of the first wall portion 111 in the Y-axis direction (third direction) is smaller than a width (length) of the first wall portion 111 in the X-axis direction (second direction). The first wall portion 111 is larger in size (area) than the second wall portion 112 and is smaller in size (area) than the third wall portion 113. In other words, in the external dimensions, the length of the first wall portion 111 in the X-axis direction is longer than a length of the second wall portion 112 in the Z-axis direction, and the length of the first wall portion 111 in the Y-axis direction is shorter than a length of the third wall portion 113 in the Z-axis direction. The first wall portion 111 is adjacent to the second wall portion 112 and the pair of third wall portions 113, and is connected to the second wall portion 112 and the pair of third wall portions 113. Specifically, the first wall portion 111 is continuously (integrally) connected to the pair of third wall portions 113. The first wall portion 111 is joined (connected) to the second wall portion 112 by welding or the like. In the present embodiment, a joint portion between the first wall portion 111 and the second wall portion 112 is a second joint portion.

The second wall portion 112 is a wall (side wall, short side wall) that forms a surface (side surface, short side surface) of the container main-body 110 in the X-axis negative direction, and is opposed to the second opening portion 115 in the X-axis direction (second direction). The second wall portion 112 is a flat plate-shaped and rectangular portion extending in the Z-axis direction parallel to a YZ plane. In the external dimensions, a width of the second wall portion 112 in the Y-axis direction (third direction) is smaller than a width (height) of the second wall portion 112 in the Z-axis direction (first direction). The second wall portion 112 is smaller in size (area) than the first wall portion 111 and the third wall portion 113. In other words, in the external dimensions, the length of the second wall portion 112 in the Z-axis direction is shorter than the length of the first wall portion 111 in the X-axis direction, and a length of the second wall portion 112 in the Y-axis direction is shorter than a length of the third wall portion 113 in the X-axis direction. The second wall portion 112 is adjacent to the first wall portion 111 and the pair of third wall portions 113, and is connected to the first wall portion 111 and the pair of third wall portions 113. Specifically, the second wall portion 112 is continuously (integrally) connected to the pair of third wall portions 113, and is connected (joined) to the first wall portion 111 by welding or the like as described above.

In the second wall portion 112, a first joint portion 112a in which two portions constituting the second wall portion 112 are joined to each other is formed. The first joint portion 112a is a linear portion which is formed in the central portion of the second wall portion 112 in the Y-axis direction and extends in the Z-axis direction from one end edge to an other end edge of the second wall portion 112 in the Z-axis direction. The first joint portion 112a is formed by joining a pair of portions extending from the pair of third wall portions 113. Specifically, a pair of rectangular portions continuously extending from the pair of third wall portions 113 are bent in a direction approaching each other, and end portions of the pair of portions are joined to each other by welding or the like. Thus, a joined portion (a welded portion or a welded mark) of the pair of portions serves as a first joint portion 112a. A method of forming the first joint portion 112a (a process of manufacturing the container main-body 110) will be described in detail below.

The pair of third wall portions 113 are a pair of walls (both side walls and a pair of long side walls) forming both surfaces (both side surfaces and a pair of long side surfaces) of the container main-body 110 in the Y-axis direction, and opposed to each other in the Y-axis direction (a third direction intersecting with the first direction and the second direction). The third wall portion 113 is a long-sized portion having a flat plate shape and a rectangular shape which extends in the X-axis direction parallel to an XZ plane. In the external dimensions, a width (height) of the third wall portion 113 in the Z-axis direction (first direction) is smaller than a width (length) of the third wall portion 113 in the X-axis direction (second direction). The third wall portion 113 is larger in size (area) than the first wall portion 111 and the second wall portion 112. The pair of third wall portions 113 are adjacent to the first wall portion 111 and the second wall portion 112. and are connected to the first wall portion 111 and the second wall portion 112. Specifically, the pair of third wall portions 113 is continuously (integrally) connected to the first wall portion 111 and the second wall portion 112.

The first opening portion 114 is an opening formed by opening the entire surface of the container main-body 110 in the Z-axis positive direction (the surface opposed to the first wall portion 111). The first opening portion 114 is a rectangular opening portion, which is surrounded by the second wall portion 112 and the pair of third wall portions 113 and extends in the X-axis direction, and a width in the Y-axis direction (third direction) is smaller than a width (length) in the X-axis direction (second direction).

The second opening portion 115 is an opening formed by opening the entire surface of the container main-body 110 in the X-axis positive direction (surface opposed to the second wall portion 112). The second opening portion 115 is a rectangular opening portion, which is surrounded by the first wall portion 111 and the pair of third wall portions 113 and extends in the Z-axis direction, and a width in the Y-axis direction (third direction) is smaller than a width (height) in the Z-axis direction (first direction).

The first opening portion 114 is larger in size (opening area) than the second opening portion 115. In other words, a length of the first opening portion 114 in the X-axis direction is longer than a length of the second opening portion 115 in the Z-axis direction. The first opening portion 114 is adjacent to the second opening portion 115 and is continuously connected to the second opening portion 115.

In this manner, the container main-body 110 integrally includes the first wall portion 111, the second wall portion 112, and the pair of third wall portions 113, and has a configuration that is open in the Z-axis direction and the X-axis direction. Namely, the container main-body 110 is a container main-body having four surfaces, which is formed by bending a single plate. Hereinafter, a manufacturing process of such a container main-body 110 will be described.

As illustrated in FIG. 3(a), one flat plate integrally including the first wall portion 111, the pair of third wall portions 113, and a pair of extension portions 113a extending from the pair of third wall portions 113 is prepared. The first wall portion 111 is a rectangular portion that is long in the X-axis direction, and the pair of third wall portions 113 are rectangular portions that are long in the X-axis direction, which are disposed on both sides of the first wall portion 111 in the Y-axis direction. The pair of extension portions 113a are rectangular portions that are long in the Y-axis direction, which are disposed while extending in the X-axis negative direction from the pair of third wall portions 113, respectively.

Next, as illustrated in FIG. 3(b), the pair of third wall portions 113 are bent with respect to the first wall portion 111, and the pair of extension portions 113a are bent with respect to the pair of third wall portions 113. Specifically, the pair of third wall portions 113 are bent in such a way as to rise from the first wall portion 111 in the Z-axis positive direction, and the pair of extension portions 113a are bent in such a way as to protrude from the pair of third wall portions 113 toward each other in the Y-axis direction. The order of bending the pair of third wall portions 113 and bending the pair of extension portions 113a is not particularly limited, and any portion may be bent first.

Thus, the pair of extension portions 113a are disposed in such a way that the sides at the tip ends in the Y-axis direction are in contact with each other in the Y-axis direction. Further, the pair of extension portions 113a are disposed in such a way that the sides in the Z-axis negative direction are in contact with the sides of the first wall portion 111 in the X-axis negative direction.

In this state, as illustrated in FIG. 3(c), a laser beam is irradiated to a position where the sides of the tip ends of the pair of extension portions 113a in the Y-axis direction are in contact with each other, and the sides are laser-welded (butt-welded) to each other. Thus, the first joint portion 112a extending in the Z-axis direction is formed. As described above, a first joint portion 112a is formed by butt-welding a section where the pair of extension portions 113a are in contact with each other in the Y-axis direction, whereby the flat plate-shaped second wall portion 112 having a plane surface (flat surface) is formed. Boundary portions of the pair of extension portions 113a and the first wall portion 111 are also irradiated with laser beam and laser-welded.

Referring back to FIG. 2, the lid body 120 is a member that closes the first opening portion 114 and the second opening portion 115 of the container main-body 110. In the present embodiment, the container main-body 110 and the lid body 120 are metal members, and the lid body 120 is welded and joined to the container main-body 110 by laser welding or the like, whereby the lid body 120 closes the opening portion of the container main-body 110.

The lid body 120 includes a fourth wall portion 121 facing in the Z-axis direction and a fifth wall portion 122 facing in the X-axis direction. Specifically, the lid body 120 integrally includes the fourth wall portion 121 and the fifth wall portion 122. Namely, the lid body 120 is a lid body having two surfaces, which is formed by bending a single plate.

The fourth wall portion 121 is a wall (upper wall) that forms a surface (upper surface, terminal disposition surface) of the lid body 120 in the Z-axis positive direction. The fourth wall portion 121 is opposed to the first wall portion 111 of the container main-body 110 in the Z-axis direction and closes the first opening portion 114 of the container main-body 110. The fourth wall portion 121 is a long-sized portion having a flat plate shape and a rectangular shape, which extends in the X-axis direction parallel to the XY plane. In the external dimensions, a width of the fourth wall portion 121 in the Y-axis direction is smaller than a width (length) of the fourth wall portion 121 in the X-axis direction. The fourth wall portion 121 is larger in size (area) than the fifth wall portion 122. In other words, in the external dimensions, the length of the fourth wall portion 121 in the X-axis direction is longer than a length of the fifth wall portion 122 in the Z-axis direction. The fourth wall portion 121 is adjacent to the fifth wall portion 122 and is continuously (integrally) connected to the fifth wall portion 122.

The gas discharge valve 130 described above is provided in the fourth wall portion 121. Further, the fourth wall portion 121 has a pair of terminal attachment portions 121a at both end portions in the X-axis direction, to which the pair of electrode terminals 200 are attached. The terminal attachment portion 121a is a through hole into which a shaft portion (not illustrated) of the electrode terminal 200 is inserted. The electrode terminal 200 is fixed to the fourth wall portion 121 together with the current collector 400 by inserting the shaft portion into the terminal attachment portion 121a and a through hole (not illustrated) of the current collector 400 and caulking the shaft portion.

The fourth wall portion 121 is disposed adjacent to the second wall portion 112 and the pair of third wall portions 113, and is joined to the second wall portion 112 and the pair of third wall portions 113. The fourth wall portion 121 has a larger width in the X-axis direction and the Y-axis direction than that of the first opening portion 114. Namely, in the external dimensions in the X-axis direction (second direction), the width of the fourth wall portion 121 which is a wall portion closing the first opening portion 114 is larger than the width of the third wall portion 113. In the Y-axis direction (third direction), the width (external dimension) of the fourth wall portion 121 is larger than a distance between the pair of third wall portions 113. Thus, the fourth wall portion 121 closes the first opening portion 114 in a state of covering the entire first opening portion 114.

The fifth wall portion 122 is a wall (side wall, short side wall) that forms a surface (side surface, short side surface) of the lid body 120 in the X-axis positive direction. The fifth wall portion 122 is opposed to the second wall portion 112 of the container main-body 110 in the X-axis direction and closes the second opening portion 115 of the container main-body 110. The fifth wall portion 122 is a flat plate-shaped and rectangular portion extending in the Z-axis direction parallel to the YZ plane, and the width in the Y-axis direction is smaller than the width (height) in the Z-axis direction.

The fifth wall portion 122 is disposed adjacent to the first wall portion 111 and the pair of third wall portions 113, and is joined to the first wall portion 111 and the pair of third wall portions 113. The fifth wall portion 122 has a larger width in the Z-axis direction and the Y-axis direction than that of the second opening portion 115. Namely, in the external dimension in the Z-axis direction (first direction), the width of the fifth wall portion 122 which is a wall portion closing the second opening portion 115 is larger than the width of the third wall portion 113. In the Y-axis direction (third direction), the width (external dimension) of the fifth wall portion 122 is larger than the distance between the pair of third wall portions 113. Accordingly, the fifth wall portion 122 closes the second opening portion 115 in a state of covering the entire second opening portion 115.

### 3 Description of Effects

As described above, in the energy storage device 10 according to the embodiment of the present invention, the container main-body 110 of the container 100 includes the first wall portion 111 opposed to the first opening portion 114 in the Z-axis direction (first direction), the second wall portion 112 opposed to the second opening portion 115 in the X-axis direction (second direction), and the pair of third wall portions 113 opposed to each other in the Y-axis direction (third direction). When a container main-body having five surfaces is formed by press working (deep drawing molding) or the like, it is difficult to manufacture the container main-body, and when the container main-body having five surfaces is formed by bending a flat plate, there is a problem such as a decrease in material yield. In particular, as in the present embodiment, in a long-sized container, it is very difficult to form a container main-body having five surfaces by press working, and when the container main-body having five surfaces is formed by bending a flat plate, the material yield is greatly reduced. In a case where a container main-body having three surfaces is formed, it may be difficult to perform alignment when the second wall portion 112 is joined to the container main-body having three surfaces. On the other hand, since the container main-body 110 can be easily formed by forming a container main-body 110 with four surfaces, the shape accuracy and the productivity of the container 100 can be improved. By forming the container main-body 110 with four surfaces, a decrease in material yield can also be suppressed.

Specifically, the container main-body 110 formed by four surfaces can be easily formed by bending a single plate. Therefore, the yield of the material can be improved, and the wall thickness of the container main-body 110 can be made uniform. Since positions of the container main-body 110 formed by four surfaces and the lid body 120 formed by two surfaces can be easily aligned, a joint position can be set with high accuracy. As a result, the container main-body 110 and the lid body 120 can be easily and airtightly welded at a uniform welding depth.

It is preferable that the electrode assembly 300 accommodated in the container 100 has a large size, but it is difficult to insert the electrode assembly 300 having a large size into the container main-body having five surfaces. In particular, in the case of the long-sized container 100 as in the present embodiment, it is difficult to insert the long-sized electrode assembly 300 into the long-sized container main-body having five surfaces. In contrast, in the case of the container main-body 110 having four surfaces in which the first opening portion 114 and the second opening portion 115 are formed, even the electrode assembly 300 having a large size can be easily inserted into the container main-body 110, and thus the electrode assembly 300 can be easily accommodated in the container 100. As described above, the degree of freedom at a time of combining the electrode assembly 300 and the container 100 is high, and a filling rate of the electrode assembly 300 with respect to an internal volume of the container 100 can be increased. At a time of manufacturing the container 100, the number of welded portions can be reduced as compared with the container disclosed in Patent Literature 1 (the container in which two flat plates are welded to the container main-body having three surfaces), and thus the manufacturing process can be simplified.

The first joint portion 112a is formed in the second wall portion 112. In this way, by forming the second wall portion 112 by joining two portions, it is possible to easily form the container main-body 110 having four surfaces which includes the first wall portion 111, the second wall portion 112, and the pair of third wall portions 113.

By forming the first joint portion 112a in the second wall portion 112 which is smaller in size than the first wall portion 111, the first joint portion 112a can be shortened in length, and therefore, the joining work is easy.

Since the lid body 120 is formed by two surfaces of the fourth wall portion 121 and the fifth wall portion 122 which close the first opening portion 114 and the second opening portion 115, it is possible to easily align the container main-body 110 and the lid body 120. Accordingly, since it is easy to dispose the lid body 120 having two surfaces on the container main-body 110 having four surfaces (it is possible to easily press the lid body 120 against the reference position), it is easy to perform a joining work between the container main-body 110 and the lid body 120.

The second wall portion 112 can be easily formed by forming the second wall portion 112 by joining the pair of portions (the pair of extension portions 113a) extending from the pair of third wall portions 113.

Since the width of the second wall portion 112 of the container main-body 110 in the Y-axis direction (third direction) is smaller than the width thereof in the Z-axis direction (first direction), the elongated lid body 120 is disposed on the container main-body 110. Accordingly, the container main-body 110 and the lid body 120 can be easily aligned with each other, and therefore, the joining work of the container main-body 110 and the lid body 120 can be easily performed. Since the width of the second wall portion 112 in the Y axis direction is smaller than the width thereof in the Z axis direction, it is possible to suppress a decrease in the material yield of the container main-body 110.

By disposing both of the pair of electrode terminals 200 on the lid body 120, the container main-body 110 and the lid body 120 can be joined to each other in a state where members (the current collector 400, the electrode assembly 300, and the like) disposed in the container 100 are fixed to the lid body 120. Therefore, the energy storage device 10 can be easily manufactured.

The fourth wall portion 121 and the fifth wall portion 122 of the lid body 120 are larger than the widths of the third wall portion 113 in the X-axis direction and the Z-axis direction, and are larger than the distance between the pair of third wall portions 113 in the Y-axis direction (third direction). Accordingly, since the lid body 120 covers the opening portions (the first opening portion 114 and the second opening portion 115) of the container main-body 110, the container main-body 110 and the lid body 120 can be easily aligned by pressing the lid body 120 against the container main-body 110. Since the lid body 120 covers the opening portion of the container main-body 110, when the container main-body 110 and the lid body 120 are laser-welded, the laser can be prevented from passing into the container main-body 110. Accordingly, it is possible to prevent the electrode assembly 300 and the like accommodated in the container main-body 110 from being damaged by the laser.

### 4 Description of Modification Examples

The energy storage device 10 according to the present embodiment has been described above. but the present invention is not limited to the above-described embodiment. These disclosed embodiments are described by way of example only in every respect, but not restrictive, and the scope of the present invention includes all modifications within the meaning and scope equivalent to the scope of the claims.

### Modification Example 1

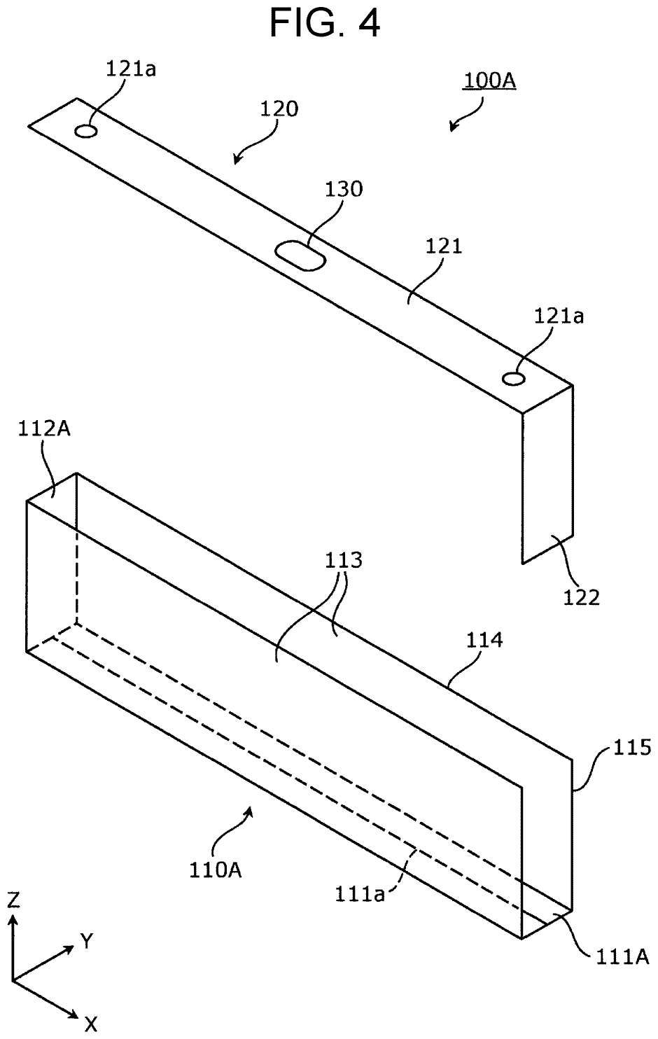

In the above-described embodiment, it is assumed that the first joint portion 112a is formed in the second wall portion 112, but the first joint portion may be formed in the first wall portion 111. FIG. 4 is a perspective view illustrating a configuration of a container 100A according to a modification example 1 of the present embodiment. FIG. 4 is a view corresponding to FIG. 2.

As illustrated in FIG. 4, in the present modification example, the container 100A includes a container main-body 110A instead of the container main-body 110 of the container 100 in the above embodiment. The container main-body 110A includes a first wall portion 111A and a second wall portion 112A instead of the first wall portion 111 and the second wall portion 112 of the container main-body 110 in the above-described embodiment. Other configurations of the present modification example are the same as those of the above-described embodiment, and thus detailed description thereof will be omitted.

The second wall portion 112A does not include the first joint portion 112a in the above embodiment, and the first wall portion 111A includes a first joint portion 111a. Namely, in the first wall portion 111A, a first joint portion 111a in which two portions constituting the first wall portion 111A are joined is formed. The first joint portion 111a is a linear portion that is formed in the central portion of the first wall portion 111A in the Y-axis direction and that extends in the X-axis direction from one end edge to an other end edge of the first wall portion 111A in the X-axis direction. The first joint portion 111a is formed by joining a pair of portions extending from a pair of third wall portions 113. Specifically, a pair of rectangular portions continuously extending from the pair of third wall portions 113 are bent in a direction approaching each other, and end portions of the pair of portions are joined to each other by welding (laser welding (butt-welding)) or the like. Thus, a joined portion (a welded portion or a welded mark) of the pair of portions serves as a first joint portion 111a. A method of forming the first joint portion 111a (a process of manufacturing the container main-body 110A) is the same as the method of forming the first joint portion 112a (the process of manufacturing the container main-body 110) in the above embodiment, and thus a detailed description thereof will be omitted.

As described above, according to the present modification example, the same effects as those of the above-described embodiment can be achieved. In particular, in the present modification example, the first joint portion 111a is formed in the first wall portion 111A. In this way, the first wall portion 111A is formed by joining two portions, whereby it is possible to configure a container main-body 110A having four surfaces, the container main-body 110A including the first wall portion 111A, the second wall portion 112A, and the pair of third wall portions 113. The first wall portion 111A is formed by joining the pair of portions extending from the pair of third wall portions 113, whereby the first wall portion 111A can be easily formed. As a result, the shape accuracy of the container 100A can be improved as in the above-described embodiment.

### Modification Example 2

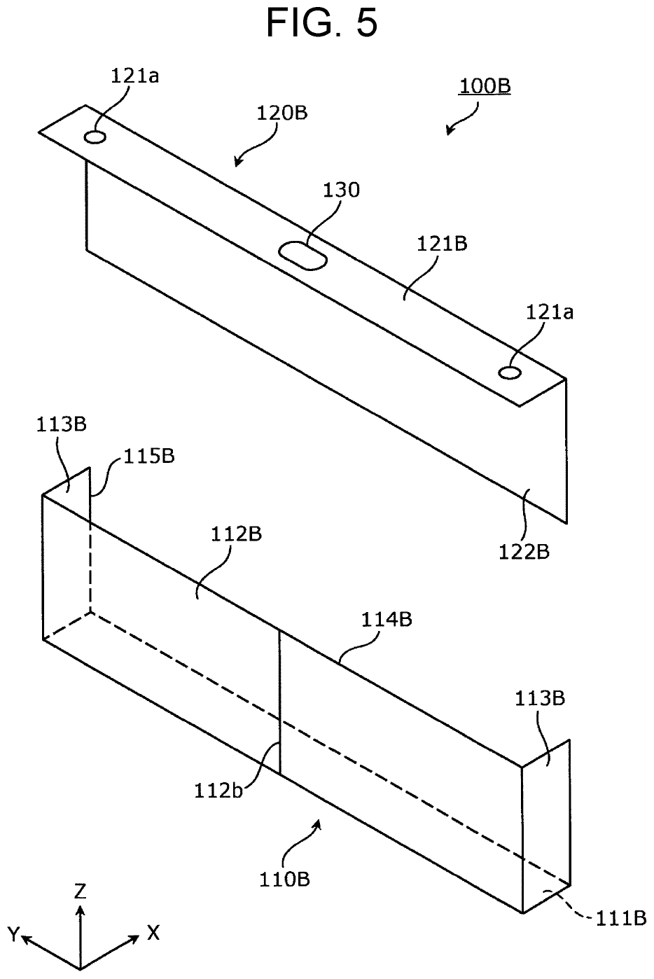

In the above embodiment, the container 100 has a rectangular parallelepiped shape that is flat in the Y-axis direction, but may have a rectangular parallelepiped shape that is flat in the X-axis direction. FIG. 5 is a perspective view illustrating a configuration of a container 100B according to a modification example 2 of the present embodiment. FIG. 5 is a view corresponding to FIG. 2, but illustrates a view in which the coordinate axes in FIG. 2 are rotated by 90° around the Z axis for convenience of explanation.

As illustrated in FIG. 5, in this modification example, the container 100B includes a container main-body 110B and a lid body 120B instead of the container main-body 110 and the lid body 120 of the container 100 in the above-described embodiment. The container main-body 110B integrally has a first wall portion side 111B facing in the Z-axis direction, a second wall portion 112B facing in the X-axis direction, and a pair of third wall portions 113B facing in the Y-axis direction, similarly to the container 100 in the above-described embodiment. Thus, the container main-body 110B includes a first opening portion 114B that is opened in the Z-axis direction and a second opening portion 115B that is opened in the X-axis direction. The lid body 120B integrally includes a fourth wall portion 121B facing in the Z-axis direction and a fifth wall portion 122B facing in the X-axis direction, and closes the first opening portion 114B and the second opening portion 115B of the container main-body 110B, similarly to the lid body 120 in the above-described embodiment.

In this modification example, the container 100B has a rectangular parallelepiped shape that is flat in the X-axis direction, unlike the container 100 in the above-described embodiment. Namely, in the external dimensions of the container main-body 110B, a width (length) of the first wall portion 111B in the Y-axis direction are larger than the width of the first wall portion 111B in the X-axis direction. The first wall portion 111B is smaller in size (area) than the second wall portion 112B and larger in size (area) than the third wall portion 113B. In the external dimensions, a width (length) of the second wall portion 112B in the Y-axis direction are larger than a width (height) of the second wall portion 112B in the Z-axis direction. The second wall portion 112B is larger in size (area) than the first wall portion 111B and the third wall portion 113B. A first joint portion 112b, which is similar to the first joint portion 112a in the above-described embodiment, is formed in the second wall portion 112B. In the external dimensions, a width (height) of the third wall portion 113B in the Z-axis direction are larger than a width thereof in the X-axis direction.

The third wall portion 113B is smaller in size (area) than the first wall portion 111B and the second wall portion 112B. The first opening portion 114B has a larger width (length) in the Y-axis direction than a width in the X-axis direction. The second opening portion 115B has a larger width (length) in the Y-axis direction than a width (length) in the Z-axis direction. The first opening portion 114B is smaller in size (opening area) than the second opening portion 115B.

In the external dimensions, a width (length) of the fourth wall portion 121B in the Y-axis direction is larger than a width of the fourth wall portion 121B in the X-axis direction. Similarly to the fourth wall portion 121 in the above-described embodiment, the fourth wall portion 121B is provided with a gas discharge valve 130 and a pair of terminal attachment portions 121a. In the external dimensions, a width (length) of the fifth wall portion 122B in the Y-axis direction is larger than a width (height) of the fifth wall portion 122B in the Z-axis direction. The fourth wall portion 121B is smaller in size (area) than the fifth wall portion 122B.

As described above, according to the present modification example, the same effects as those of the above-described embodiment can be achieved.

In the present modification example, it is assumed that the first joint portion 112b is formed on the second wall portion 112B, but the first joint portion may be formed on the first wall portion 111B as in the above-described modification example 1. The container 100B has a rectangular parallelepiped shape that is flat in the X-axis direction, but may have a rectangular parallelepiped shape that is flat in the Z-axis direction.

### Modification Example 3

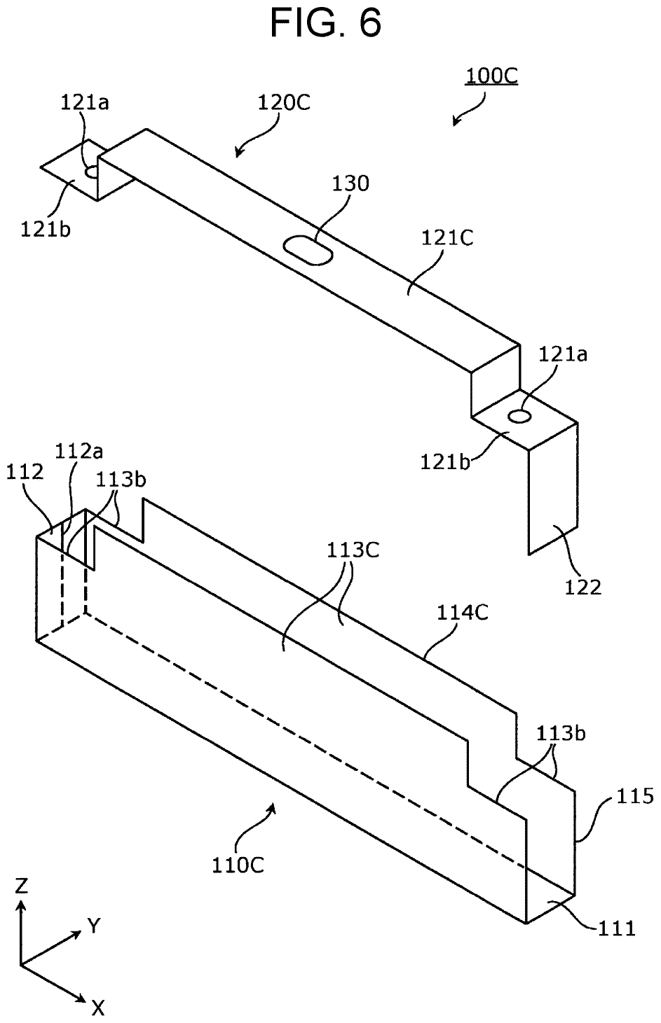

In the above embodiment, the container 100 has a rectangular parallelepiped shape, but is not limited to the rectangular parallelepiped shape. FIG. 6 is a perspective view illustrating a configuration of a container 100C according to a modification example 3 of the present embodiment. FIG. 6 is a view corresponding to FIG. 2.

As illustrated in FIG. 6, in this modification example, the container 100C includes a container main-body 110C and a lid body 120C, instead of the container main-body 110 and the lid body 120 of the container 100 in the above-described embodiment. The container main-body 110C includes a pair of third wall portions 113C, instead of the pair of third wall portions 113 included in the container 100 according to the above-described embodiment. Accordingly, the container main-body 110C has a first opening portion 114C that is opened in the Z axis direction. The lid body 120C includes a fourth wall portion 121C, instead of the fourth wall portion 121 included in the lid body 120 of the above-described embodiment. The fourth wall portion 121C closes the first opening portion 114C of the container main-body 110C. Other configurations of the present modification example are the same as those of the above-described embodiment, and thus detailed description thereof will be omitted.

The third wall portion 113C has recessed portions 113b that is recessed in the Z-axis negative direction at both end portions in the X-axis direction. The recessed portion 113b is a rectangular recessed portion provided in corner portions on both sides of the third wall portion 113C in the X-axis direction. In other words, the third wall portion 113C has a shape in which the central portion in the X-axis direction protrudes in the Z-axis positive direction.

The first opening portion 114C is an opening having a shape corresponding to the shape of the third wall portion 113C. The fourth wall portion 121C has recessed portions 121b that is recessed in the Z-axis negative direction at both end portions in the X-axis direction. The recessed portion 121b is a recessed portion penetrating in the Y-axis direction in which an end portion of the fourth wall portion 121C in the X-axis direction is recessed in a stepped shape (stepwise shape). A terminal attachment portion 121a is disposed in each of the recessed portions 121b. The recessed portion 121b is disposed at a position corresponding to the recessed portion 113b of the third wall portion 113C, and is joined to the recessed portion 113b.

As described above, according to the present modification example, the same effects as those of the above-described embodiment can be achieved. In the present modification example, the first joint portion may be formed on the first wall portion 111 as in the modification example 1. In the present modification example, the container 100C may have a rectangular parallelepiped shape that is flat in the X-axis direction or the Z-axis direction, as in the modification example 2 described above. As in the modification examples 1 and 2 described above, and the present modification example, it is possible to achieve containers of various shapes including a container main-body having four surfaces and a lid body having two surfaces, which have various shapes.

### Other Modification Examples

In the above-described embodiment, the lid body 120 integrally includes the fourth wall portion 121 and the fifth wall portion 122, but may include the fourth wall portion 121 and the fifth wall portion 122 which are separate bodies.

In the above-described embodiment, the first joint portion 112a of the second wall portion 112 is formed by joining the pair of rectangular portions extending from the pair of third wall portions 113, but the shapes of the pair of portions are not particularly limited. The pair of portions may be a pair of triangular portions or may have any other shape as long as the second wall portion 112 can be formed. The first joint portion 112a is a linear portion, but may be a bent portion or a portion in a curved-line shape. At least one of the two portions to be joined in the first joint portion 112a may be a portion extending from the first wall portion 111 instead of a portion extending from the third wall portion 113. In this case, the second wall portion 112 and the third wall portion 113 may be joined, thereby forming a second joint portion.

In the above-described embodiment, the first joint portion 112a is formed by butt-welding the pair of extension portions 113a. However, the first joint portion 112a may be formed by overlapping the pair of extension portions 113a in the thickness direction and welding a part of the overlapped portion. In this case, the second wall portion 112 may have a shape which is thick at a position of the first joint portion 112a (the position of the first joint portion 112a has a stepped shape) instead of a flat plate shape.

In the above-described embodiment, both of the pair of electrode terminals 200 are disposed on the fourth wall portion 121 of the lid body 120. However, one or both of the pair of electrode terminals 200 and may be disposed on the fifth wall portion 122, or may be disposed on any wall portion of the container main-body 110. Namely, one or both of the pair of terminal attachment portions 121a may be provided on the fifth wall portion 122, or may be provided on any of the wall portions of the container main-body 110. However, since the first joint portion 112a is formed on the second wall portion 112, it is preferable that the electrode terminals 200 (the terminal attachment portions 121a) be disposed on a wall portion other than the second wall portion 112.

Forms constructed by arbitrarily combining components included in the above-described embodiment and the modification examples thereof are also included in the scope of the present invention.

### INDUSTRIAL APPLICABILITY

The present invention can be applied to an energy storage device or the like such as a lithium-ion secondary battery.

### Description of Reference Numerals

10 ENERGY STORAGE DEVICE
100, 100A, 100B, 100C CONTAINER
110, 110A, 110B, 110C CONTAINER MAIN-BODY
111, 111A, 111B FIRST WALL PORTION
111a, 112a, 112b FIRST JOINT PORTION
112, 112A, 112B SECOND WALL PORTION
113, 113B, 113C THIRD WALL PORTION
113a EXTENSION PORTION
113b, 121b RECESSED PORTION
114, 114B, 114C FIRST OPENING PORTION
115, 115B SECOND OPENING PORTION
120, 120B, 120C LID BODY
121, 121B, 121C FOURTH WALL PORTION
121a TERMINAL ATTACHMENT PORTION
122, 122B FIFTH WALL PORTION
130 GAS DISCHARGE VALVE
200 ELECTRODE TERMINAL
300 ELECTRODE ASSEMBLY
400 CURRENT COLLECTOR

1. An energy storage device comprising a container,
wherein the container includes:
a container main-body having a first opening portion that is opened in a first direction and a second opening portion that is opened in a second direction intersecting with the first direction; and
a lid body that closes the first opening portion and the second opening portion, and
the container main-body includes:
a first wall portion that is opposed to the first opening portion in the first direction;
a second wall portion that is opposed to the second opening portion in the second direction; and
a pair of third wall portions opposed to each other in a third direction intersecting with the first direction and the second direction.

2. The energy storage device according to claim 1, wherein
the first wall portion or the second wall portion is formed with a first joint portion in which two portions constituting the first wall portion or the second wall portion are joined to each other.

3. The energy storage device according to claim 2, wherein
the second wall portion is smaller in size than the first wall portion, and
the first joint portion is formed on the second wall portion.

4. The energy storage device according to claim 1, wherein
the lid body includes a fourth wall portion that closes the first opening portion and a fifth wall portion that closes the second opening portion.

5. The energy storage device according to claim 2, wherein
the first joint portion is formed by joining a pair of portions extending from the pair of third wall portions.

6. The energy storage device according to claim 1, wherein
the second wall portion has a width in the third direction smaller than a width in the first direction.

7. The energy storage device according to claim 1, further comprising
a pair of electrode terminals, wherein
the pair of electrode terminals are disposed on the lid body.

8. The energy storage device according to claim 1, wherein
the lid body includes:
a wall portion that closes the first opening portion, and that is larger than a width of the pair of third wall portions in the second direction and larger than a distance between the pair of third wall portions in the third direction; and
a wall portion that closes the second opening portion, and that is larger than a width of the pair of third wall portions in the first direction and larger than the distance between the pair of third wall portions in the third direction.

9. The energy storage device according to claim 1, wherein
the container main-body is formed with a second joint portion in which the first wall portion or the second wall portion is joined to the third wall portion.
